(19) United States
(12) Patent Application Publication
(10) Pub. No.: US 2004/0258992 A1
(43) Pub. Date: Dec. 23, 2004

(54) Negative plate for nickel/metal hydride secondary battery and fabrication method thereof

(76) Inventor: Dong Pil Park, Kyunggi-do (KR)

Correspondence Address: CANTOR COLBURN LLP, 55 Griffin Road South, Bloomfield, CT, 06002, US

(21) Appl. No.: 10/600,169

(22) Filed: Jun. 19, 2003

(51) Int. Cl. H01M 4/58; H01M 4/66; H01M 4/04; B05D 5/12

(52) U.S. Cl. 429/218.2; 429/245; 427/123; 29/2

(57) ABSTRACT

Disclosed is a negative plate for nickel/metal hydride secondary batteries, including nickel strips bonded at upper edges and lower edges thereof, each having a plurality of perforations; and metal hydride in the form of powders held between the nickel strips. Also, a method of fabricating such a negative plate includes perforating each of collectors to have a plurality of perforations, filling powders of metal hydride between the collectors, and compressing the collectors having the powders the of metal hydride filled therebetween, so that the powders of metal hydride are contained between the collectors.

### BACKGROUND OF THE INVENTION

1. Field of the Invention

The present invention relates to a nickel/metal hydride secondary battery, and more particularly, to a negative electrode plate for rechargeable nickel/metal hydride secondary batteries, and a method of fabricating the same.

2. Description of the Related Art

With great advances in the electronic techniques, there have recently been developments in small, portable and lightweight electric and electronic appliances. Hence, the demand for secondary batteries with long lifetime and high power output, such as nickel/metal hydride battery, is increasing rapidly.

As for the nickel/metal hydride secondary battery, negative plates therein has a function of emitting and absorbing hydrogen ions at the time of charging and discharging the battery, and also a function of absorbinbg gases produced at positive plates when the battery is overcharged. Thus, characteristics (e.g., charge and discharge cycle life and high rate discharge) of the nickel/metal hydride secondary battery are mainly dependent upon performances of the negative plates.

Examples of conventional methods of fabricating negative plates for nickel/metal hydride secondary batteries include a fabrication method for a paste-type metal hydride electrode developed by KIST (Korea Institute of Science and Technology), Korea, which is disclosed in U.S. Pat. No. 5,682,592.

According to U.S. Pat. No. 5,682,592, the negative plate is fabricated by mixing a powder-type active material (that is, metal hydride), a binder, a conductor and water at predetermined mixing ratios, and compressing the mixture on nickel screens serving as a collector. At this time, the binder is exemplified by a binding agent (PTFE: polytetrafluoroethylene and 503H) and a thickening agent (HPMC: hydroxypropyl methyl cellulose). As the conductor, nickel, copper, graphite or AB (acetylene black) in the form of powders is used in an amount of 5-10 wt %.

However, in the negative plate for nickel/metal hydride electrode fabricated according to conventional methods, quantities of metal hydride powders decrease proportionally to an increasing quantity of the binder and the conductor, thus reducing the capacity of the secondary battery using such negative plates. In addition, since the metal hydride powders are applied to an outer wall of the nickel screens, detachment of unreacted metal hydride from the electrode takes place upon discharge. With reference to FIG. 1, a cycle life of the nickel/metal hydride secondary battery using the negative plates according to conventional techniques is shown. As shown in FIG. 1, after charge and discharge cycles of the battery are repeated about 500 times, a discharge capacity thereof decreases to about 80%.

Further, conventional negative plates are disadvantageous in that when the electric current flows from the collector (nickel screen) to the metal hydride, the used binder acts as a resistance. Accordingly, as shown in FIG. 2, the nickel/metal hydride secondary battery using the negative plates according to conventional techniques has a discharge rate not exceeding about 95% for about 1 hour, on the basis of a 5-hour discharge rate of 100%. In the horizontal axis in FIG. 2, the term ‘Ah’ stands for Ampere-hour.

### SUMMARY OF THE INVENTION

The present invention alleviates the problems in the conventional negative plates for nickel/metal hydride secondary batteries.

The present invention provides a negative plate for nickel/metal hydride secondary batteries, comprising nickel strips facing each other, the nickel strips each having a plurality of perforations, and metal hydride in the form of powders held between the nickel strips.

In addition, the present invention provides a method of fabricating a negative plate for nickel/metal hydride secondary batteries, comprising the steps of perforating each of collectors to have a plurality of perforations, filling powders of metal hydride between the collectors, and compressing the collectors having the powders of the metal hydride filled therebetween so that the powders of metal hydride are contained between the collectors.

### BRIEF DESCRIPTION OF THE DRAWINGS

The above and other objects, features and other advantages of the present invention will be better understood from the following detailed description taken in conjunction with the accompanying drawings, in which:

FIG. 1 is a graph schematically illustrating a cycle life of a conventional nickel/metal hydride secondary battery;

FIG. 2 is a graph schematically illustrating high rate discharge of a conventional nickel/metal hydride secondary battery;

FIG. 3A is a front view illustrating a structure of a negative plate for nickel/metal hydride secondary batteries of the present invention;

FIG. 3B is a sectional view taken along line A-A′ of FIG. 3A;

FIG. 4 is a process diagram illustrating a method of fabricating the negative plate for nickel/metal hydride secondary batteries of the present invention;

FIG. 5 is a perspective view illustrating a structure of a nickel/metal hydride secondary battery using the negative plates of the present invention;

FIG. 6 is a graph illustrating a cycle life of the nickel/metal hydride secondary battery using the negative plates of the present invention; and

FIG. 7 is a graph illustrating high rate discharge of the nickel/metal hydride secondary battery using the negative plates of the present invention.

### DETAILED DESCRIPTION OF THE INVENTION

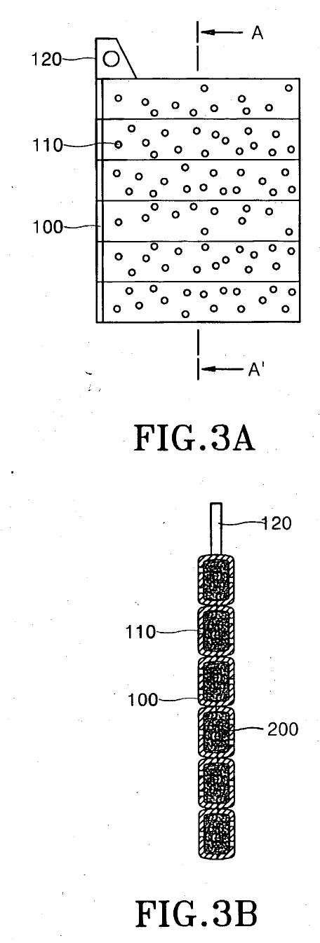

Hereinafter, a detailed description will be given of exemplary embodiments a negative plate for nickel/metal hydride secondary batteries and a method of fabricating the same, with reference to FIGS. 3a to 7.

As shown in FIGS. 3A and 3B, a negative plate for nickel/metal hydride secondary batteries includes a plurality of nickel strips 100 arranged in two rows, and metal hydride 200 filled between the nickel strips 100 facing each other.

Each of the nickel strips 100 includes a multiplicity of perforations 110. For example, each perforation has a diameter in the range from tens of nanometers to hundreds of nanometers. A terminal 120 for charging and discharging the battery is formed at the nickel strip 100 and positioned at an end portion of the negative plate. The nickel strips 100 function as an electric collector. In other words, when electric current is applied to the terminal 120, the nickel strips 100 allow electric current to flow to the metal hydride 200. For example, the nickel strips 100 are each made of nickel or nickel-plated iron having a strip form.

Such metal hydride 200, serving as a hydrogen storage, is made of material including AB₅ based alloys (e.g., MmNi_{3.55}Cu_{0.75}Mn_{0.4}Al_{0.3} (Misch metal, alloy of rare earth elements), MmNi_{4.3}Mn_{0.4}Al_{0.3}, etc.) or AB₂ based alloys (e.g., Ti₁₋ₓZrₓV_{0.5}Ni_{1.1}Fe_{0.2}Mn_{0.2}, etc.).

Powders of the metal hydride 200 are preferably coated with either nickel (Ni) or copper (Cu) to improve battery characteristics, such as the prevention of self-discharge of the battery, inhibition of high temperature corrosion, and high rate charge and discharge characteristics. Also, the metal hydride 200 may be coated with a mixture of nickel and copper.

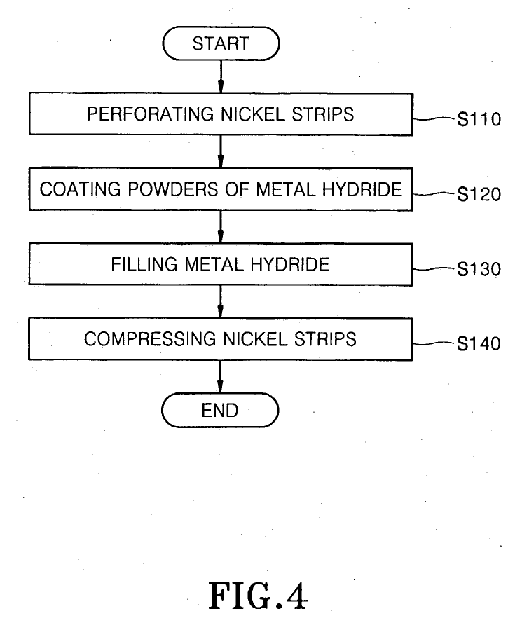

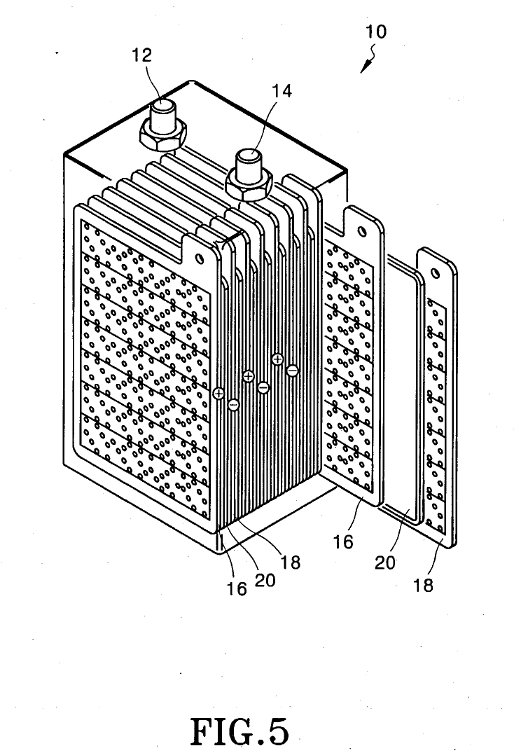

FIG. 4 is a process diagram illustrating a method of fabricating the negative plate for nickel/metal hydride secondary batteries. As shown in FIG. 4, each of the nickel strips 100 is perforated to have a plurality of perforations at step S110. Powders of metal hydride 200 are coated with either nickel (Ni) or copper (Cu) at step S120. Then, the powder type metal hydride 200 is filled between the two nickel strips 100 facing each other at step S130. The nickel strips 100 having powders of the metal hydride 200 filled therebetween are compressed by external pressure at step S140. As a result, each pair of nickel strips 100 facing each other are combined at upper edges and lower edges thereof, respectively, and the powders of the metal hydride 200 are held in the combined nickel strips 100. In other words, the metal hydride 200 is contained in every pair of two nickel strips 100 combined with each other. In order to prevent a reaction of the metal hydride with moisture in the air, fabrication of the negative plate is performed under the conditions of room temperature and a dry atmosphere.

Since the negative plate of the present invention comprises the metal hydride 200 held between the combined nickel strips 100, detachment of the metal hydride 200 is prevented at the time discharging the battery. Further, since a binder and a conductor are not used in the present invention, a quantity of the metal hydride contained in the negative plate of the present invention is much larger than that in a negative plate according to conventional techniques.

Moreover, because the nickel strips 100 are disposed at both sides of the metal hydride 200, functions of the nickel strips 100 as the collector can be enhanced even though a conductor is not used. When the electric current flows to the metal hydride 200 from the nickel strips 100, contact resistance between the nickel strips 100 and the metal hydride 200 is considerably decreased, compared to the conventional negative conventional plates using a binder. Thus, the high rate discharge characteristics of secondary batteries are effectively increased in a secondary battery employing the negative plate of the present invention.

FIG. 5 is a perspective view illustrating a nickel/metal hydride secondary battery including the negative plates according to the present invention. As shown in FIG. 5, the nickel/metal hydride secondary battery comprises a housing 10, a positive terminal 12 and a negative terminal 14 each protruding from the housing 10, positive plates 16 connected to the positive terminal 12, negative plates 18 connected to the negative terminal 14, and separators 20 interposed between the positive plates 16 and the negative plates 18. The positive plates 16, the negative plates 18 and the separators 20 are received in the housing 10.

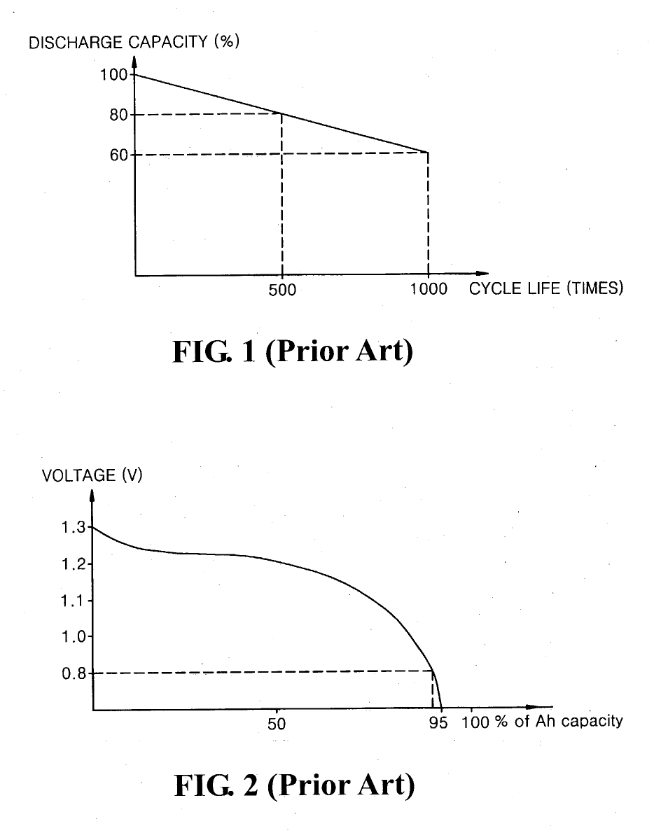

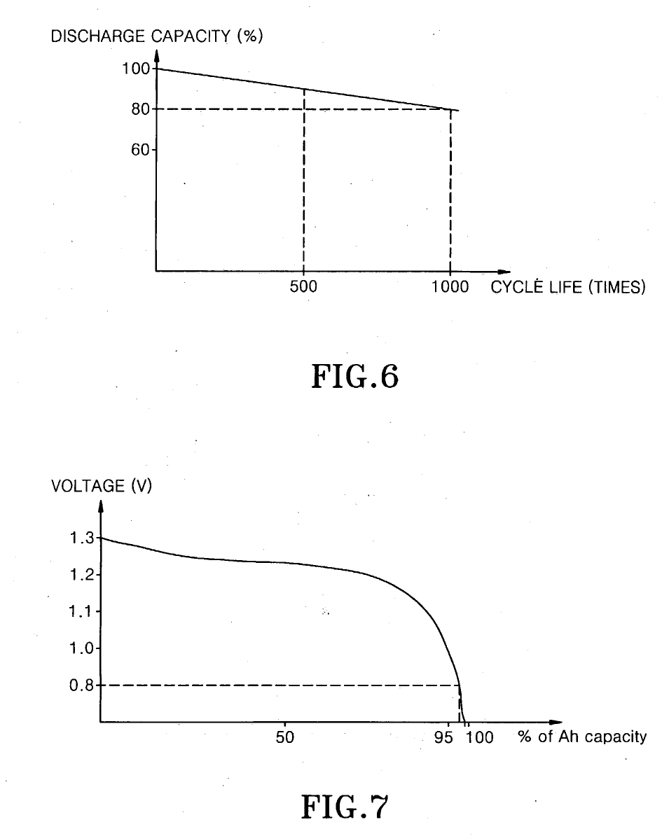

Referring to FIG. 6, a cycle life of the nickel/metal hydride battery having the negative plates of the present invention is shown. As shown in FIG. 6, when charge and discharge cycles of such a battery are repeated about 1000 times, a discharge capacity of the battery is close to about 80%. That is, conventional secondary batteries have a discharge capacity of about 80% upon about 500 repetitions of charge and discharge cycles (FIG. 1), while the secondary battery having the negative plates according to the present invention has a discharge capacity of about 80% upon about 1000 repetitions of charge and discharge cycles (FIG. 6).

Turning now to FIG. 7, there is shown a high rate discharge characteristic of the nickel/metal hydride secondary battery having the negative plates of the present invention. As shown in FIG. 7, a discharge rate is close to about 100% for about 1 hour, on the basis of a 5-hour discharge rate of 100%. Also, until the battery voltage becomes about 0.8V, secondary batteries having the conventional negative plates have a discharge rate not exceeding about 95% (FIG. 2), whereas the secondary batteries having the negative plates according to the present invention have a discharge rate exceeding about 95% (FIG. 7). In the horizontal axis in FIG. 7, the term ‘Ah’ stands for Ampere-hour.

As described above, the present invention provides a negative plate for nickel/metal hydride secondary batteries, in which porous nickel strips, serving as an electric collector, are disposed at both sides of metal hydride by a compressing process. Thereby, even though a binder is not used, metal hydride is contained between the collectors. In addition, electric current flows efficiently to the metal hydride from the collectors, even though a conductor is not used.

Therefore, the secondary battery having negative plates of the present invention has, but not limited to, the following advantages:

(1) While a quantity of metal hydride used for the negative plates of the present invention is much larger than that for conventional negative plates using a binder and a conductor, detachment of metal hydride does not occur. Thus, a cycle life of the secondary battery having the negative plates of the present invention is remarkably lengthened.

(2) Since contact resistance between the collectors and the metal hydride is decreased considerably, high rate discharge characteristics of the secondary battery having the negative plates of the present invention is significantly enhanced.

(3) Due to the above advantages, the secondary battery having negative plates of the present invention is applicable to industrial batteries requiring super high rate charge/discharge characteristics and very long cycle life.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

What is claimed is:

1. A method of fabricating a negative plate for nickel/metal hydride secondary batteries, comprising:
perforating each of collectors to have a plurality of perforations;
filling powders of metal hydride between the perforated collectors; and
compressing the collectors having the powders of the metal hydride filled therebetween, so that the powders of the metal hydride are contained between the collectors.

2. The method as defined in claim 1, further comprising coating the powders of the metal hydride with one of nickel, copper and a mixture of nickel and copper.

3. The method as defined in claim 2, wherein the coating of the powders of the metal hydride is performed prior to the filling of the powders of the metal hydride.

4. The method as defined in claim 1, further comprising forming each of the collectors in a strip form.

5. The method as defined in claim 4, wherein the collectors are made of nickel.

6. A negative plate for nickel/metal hydride secondary batteries, comprising
at least two nickel strips facing each other, the nickel strips each having a plurality of perforations; and
metal hydride in the form of powders held between the nickel strips.

7. The negative plate as defined in claim 6, wherein the powders of the metal hydride are coated with one of nickel, copper and a mixture of nickel and copper.

8. The negative plate as defined in claim 6, wherein the nickel strips facing each other are combined at upper edges and lower edges thereof.

9. The negative plate as defined in claim 8, wherein the metal hydride includes one of AB₅ based alloys and AB₂ based alloys.

10. A nickel/metal secondary battery comprising:
a housing with positive and negative terminals;
a positive plate connected to positive terminal and received in a housing;
a negative plate connected to the negative terminal and received in the housing; and
a separator disposed between the positive and negative plates.

11. The nickel/metal secondary battery as defined in claim 10, wherein the negative plate comprising:
at least a pair of electric collectors facing each other, through which an externally applied electric current flows; and
metal hydride contained between the electric collectors.

12. The nickel/metal secondary battery as defined in claim 11, wherein the electric collectors are made of nickel.

13. The nickel/metal secondary battery as defined in claim 11, wherein the electric collectors are made of nickel-plated iron.

14. The nickel/metal secondary battery as defined in claim 11, wherein the electric collectors each have a strip form.

15. The nickel/metal secondary battery as defined in claim 14, wherein the electric collectors are combined at upper and lower edges thereof.

16. The nickel/metal secondary battery as defined in claim 15, wherein the metal hydride has a form of powders.

17. The nickel/metal secondary battery as defined in claim 16, wherein the powders of the metal hydride are coated with one of nickel, copper and a mixture of nickel and copper.
